(19) United States
(12) Patent Application Publication
(10) Pub. No.: US 2007/0002216 A1
(43) Pub. Date: Jan. 4, 2007

(54) Polarizer and liquid crystal display having the same

(75) Inventors: Young-joo Chang, Suwon-si (KR); Won-sang Park, Yongin-si (KR); Hyung-guel Kim, Suwon-si (KR); Kee-han Uh, Yongin-si (KR); Hae-young Yun, Suwon-si (KR); Sang-woo Kim, Suwon-si (KR); Jae-young Lee, Yongin-si (KR); Jae-ik Lim, Seoul (KR); Seung-kyu Lee, Suwon-si (KR); Sung-eun Cha, Geoje-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/479,086

(22) Filed: Jun. 30, 2006

(30) Foreign Application Priority Data
Jun. 30, 2005 (KR) 10-2005-0058438

(51) Int. Cl. G02F 1/1335

(52) U.S. Cl. 349/96; 349/58

(57) ABSTRACT

A polarizer which includes a polarization film having a transmissive region and a reflective region, the reflective region being comprised of a layer of reflective material supported

This application claims priority from Korean Patent Application No. 10-2005-0058438 filed on Jun. 30, 2005 in the Korean Intellectual Property Office, the disclosure of which is incorporated herein by reference in its entirety.

### BACKGROUND OF THE INVENTION

1. Field of the Invention

The present invention relates to a polarizer and a liquid crystal display (LCD) having the same, and more particularly, to a polarizer capable of reducing power consumption and improving display characteristics.

2. Description of the Related Art

A cathode ray tube (CRT), which is one of the generally used displays, is widely used in a television (TV) and as a monitor for an instrumentation system or in an information terminal device. However, a CRT is not suitable for use in miniaturized, light-weight electronic products due to weight and size of the CRT.

To substitute for CRTs, LCDs have been actively pursued. The LCDs have some notable advantages, such as small size, light weight, low power consumption and low driving voltages, and are capable of displaying information using electrical and optical properties of liquid crystals injected into a liquid crystal panel. Due to such advantages, LCDs are being actively researched and developed. Recently, LCDs have become the mainstream of the current flat screen display devices and are used in a wide variety of applications such as, portable computers, desktop computer monitors, monitors of high-quality image display devices, or the like.

LCDs are generally classified into two types based on the type of liquid crystal used for example, the twisted nematic (TN) type; and the super-twisted nematic (STN) type. These LCDs are also classified into an active matrix display type devices which uses switching devices and TN liquid crystal, and a passive matrix display devices type using STN liquid crystal which is driven by another technique.

The two types LCDs have apparent difference. The active matrix type display is employed in TFT-LCDs utilizing thin film transistors (TFT) as switching elements. The passive matrix display does not utilize TFT as switching element. In other words, the passive matrix display does not need complicated circuits such as TFTs. With the recent proliferation of portable computers, TFT-LCDs are widely used.

A typical active matrix liquid panel assembly includes a liquid crystal panel having two substrates, a TFT substrate and a color filter substrate. A liquid crystal material having dielectric anisotropy is interposed between the two substrates, a driving IC is provided for applying driving signals to gate lines and data lines, the driving IC being mounted on the liquid crystal panel by a chip on glass (CPG) method, and a flexible printed circuit board (PCB) for connecting the driving IC with an external PCB transmitting predetermined data and control signals. The liquid panel assembly is received in a backlight assembly, forming a LCD. The backlight assembly includes a light guide panel, a lamp assembly, and various optical sheets.

In a conventional LCD, a display screen is divided into a main display region in which image information and character information are displayed, and a sub-display region in which information such as time, date, the state of a battery are displayed. In general, information displayed in the sub-display region is frequently used by the user, regardless of information displayed in the main display region.

In the conventional LCD, use of the sub-display region and the main display region requires use of a backlight whenever information such as time,.date, the state of a battery, and the like is needed, excessive power is consumed. In addition, display characteristics of the sub-display region should be improved so that information provided in the sub-display region is clearly recognized by the user.

### SUMMARY OF THE INVENTION

The present invention provides a polarizer capable of reducing power consumption and improving display characteristics.

The present invention also provides a liquid crystal display (LCD) capable of reducing power consumption and improving display characteristics.

The above features and advantages of the present invention will become clear to those skilled in the art upon review of the following description.

According to an aspect of the present invention, there is provided a polarizer comprising a polarization film having a transmissive region and a reflective region, wherein the reflective region is comprised of a reflective layer supported on the polarization film.

According to another aspect of the present invention, there is provided a liquid crystal display comprising main display region and a sub-display region, the liquid crystal panel having first and second sides; a backlight assembly positioned adjacent the first side of the liquid crystal panel, the backlight assembly being adapted to provide incident light onto the liquid crystal panel; a lower polarizer positioned intermediate the back light assembly and the first side at the liquid crystal panel, the lower polarizer comprising a polarization film polarizing for polarizing the incident light; a reflective layer formed on the lower polarizer, wherein the reflective layer is positioned corresponding to the sub-display region; and an upper polarizer positioned adjacent to the side of the liquid crystal panel, the upper panel being adapted to polarize incident light passing through the liquid crystal panel.

### BRIEF DESCRIPTION OF THE DRAWINGS

The above and other features and advantages of the present invention will become more apparent in light of the following detailed description of the drawings in which:

FIG. 1 is an exploded perspective view of a liquid crystal display (LCD) according to an embodiment of the present invention;

FIG. 2 is a perspective view of the LCD of FIG. 1 after assembling;

FIG. 3 is a cross-sectional view taken along line III-III′ of FIG. 2;

FIG. 4 is a cross-sectional view of a polarizer included in the LCD according to an embodiment of the present invention; and

FIG. 5 illustrates the relationship between a polarizer, a thin film transistor (TFT) substrate, and a color filter substrate.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

A liquid crystal display (LCD) according to the present invention includes a portable multimedia player (PMP), a personal digital assistant (PDA), a portable digital versatile disk (DVD) player, a cellular phone, and so on. For the convenience of explanation, the LCD according to the present invention using the cellular phone will now be described. The present invention is not limited to this and includes the above-mentioned LCDs.

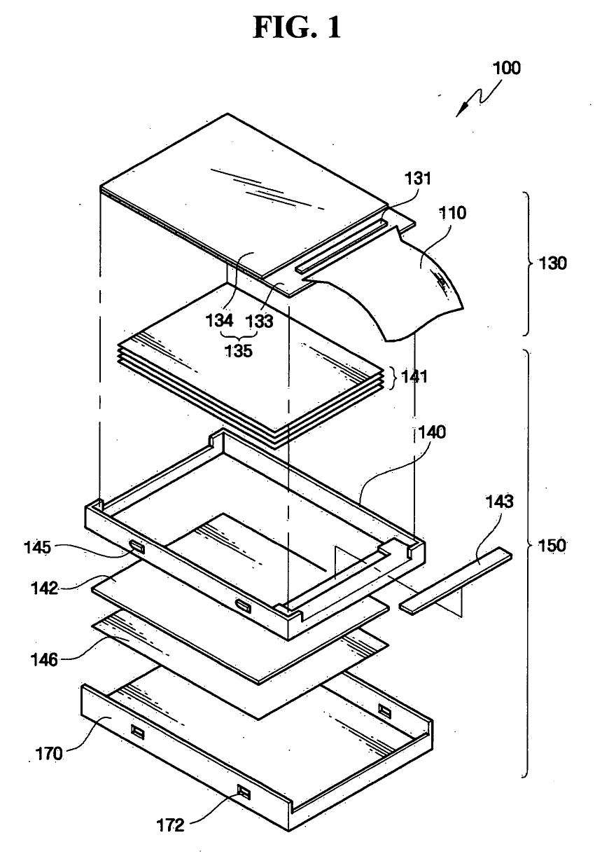

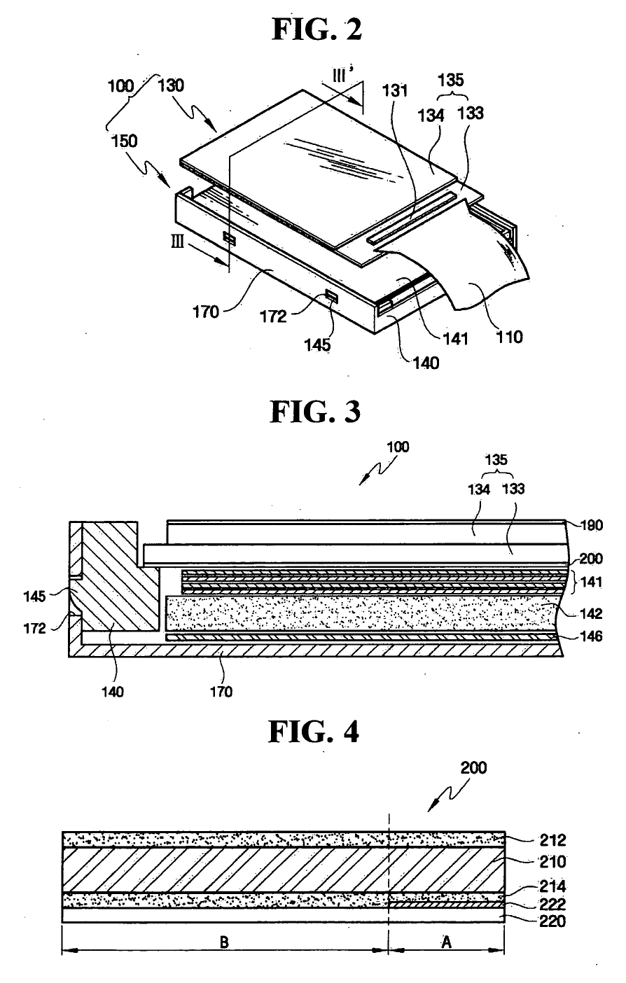

FIG. 1 is an exploded perspective view of a liquid crystal display (LCD) according to an embodiment of the present invention, FIG. 2 is a perspective view of the LCD of FIG. I after assembling, and FIG. 3 is a cross-sectional view taken along line FIG. 3 is a cross-sectional view taken along line III-III′ of FIG. 2.

Referring to FIGS. 1 through 3, the LCD 100 includes a liquid crystal panel assembly 130 and a backlight assembly 150.

Here, the liquid crystal panel assembly 130 includes a liquid crystal panel 135 having a TFT substrate 133 and a color filter substrate 134, a liquid crystal (not shown), a driving IC 13 1, and a flexible printed circuit board (FPCB) 110.

The liquid crystal panel 135 is a device which displays image information such as a character, a number, or an arbitrary icon by adjusting the transmissivity of light that passes through a liquid crystal layer (not shown) according to the intensity of an applied voltage. The liquid crystal panel 135 includes the TFT substrate 133, the color filter substrate 134, and the liquid crystal (not shown).

The TFT substrate 133 includes a plurality of gate lines, a data line, and a pixel electrode. The gate lines extend in a row direction and transmit a gate signal. The data lines extend in a column direction and transmit a data signal. A pixel is connected to the gate lines and the data line and includes a switching element and a sustain capacitor.

Here, the switching element is formed at a cross-point of the gate line and the data line, and the sustain capacitor and a liquid crystal capacitor are connected to an output terminal of the switching element. In addition, the switching element is formed as a TFT using amorphous silicon and poly-silicon as a channel layer.

Another terminal of the sustain capacitor is connected to a common voltage or the gate line directly formed on the sustain capacitor. Here, the former connection type is a separate wire type, and the latter connection type is a previous gate type.

The color filter substrate 134 is located on the TFT substrate 133 and includes a color filter that represents red, green, or blue color in a region corresponding to the pixel electrode so as to display color in each pixel. Here, the color filter may be formed above or below the pixel electrode. In addition, a common electrode formed of a transparent conductive material such as indium tin oxide (ITO) or indium zinc oxide (IZO) is formed on the color filter.

The liquid crystal layer (not shown) is filled between the color filter substrate 134 and the TFT substrate 133 and has dielectric anisotropy. The thickness of the liquid crystal layer (not shown) is about 5 μm, and the liquid crystal layer is twisted nematic (TN) type. The arrangement direction of the liquid crystal layer (not shown) is changed by a voltage applied from the outside so that the transmissivity of light passing through the liquid crystal layer (not shown) is adjusted.

The TFT substrate 133, the color filter substrate 134, and the liquid crystal layer (not shown), which are elements for the liquid crystal panel 135, constitute a liquid crystal capacitor. The liquid crystal capacitor having the above structure is connected to the output terminal of the switching element and the common voltage or a reference voltage.

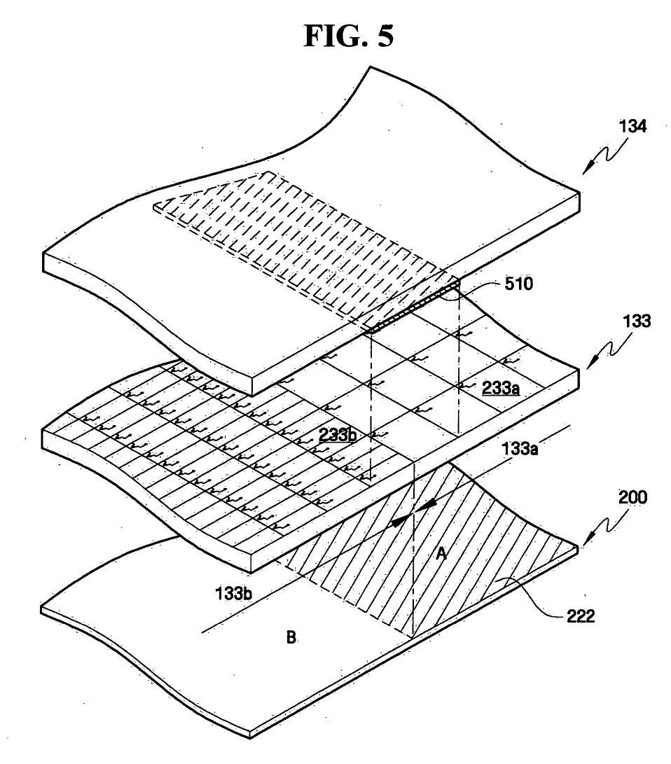

Polarizers 190 and 200 are disposed at an outside of each of the TFT substrate 133 and the color filter substrate 134 which are elements for the liquid crystal panel 135, and the backlight assembly 150 faces a side of the polarizer 200. The polarizers 190 and 200 are referred to sometimes hereinafter as upper polarizer 190 which placed at a top surface of the liquid crystal panel 135 and lower polarizer 200 which is placed at a bottom surface of the liquid crystal panel 135. Lower polarizer 200 which provides power saving and improved display characteristics according to an embodiment of the present invention is described below with reference to FIGS. 4 and 5.

The driving IC 131 is an integrated circuit (IC) which receives a gate control signal, a data control signal, and a data signal related to the data control signal from the FPCB 110 via an input terminal and provides a gate driving signal and a data driving signal to the gate line and the data line formed on the TFT substrate 133 via an output terminal. As such, a desired image can be formed on the liquid crystal panel 135.

The driving IC 131 is mounted on the TFT substrate 133 other than an image display region corresponding to the color filter substrate 134 of the TFT substrate 133 so that an output terminal of the driving IC 131 is connected to each of the gate line and the data line that extend from the image display region using chip on glass (COG). As descried above, the gate driving signal and the data driving signal generated by the driving IC 131 are transmitted to each pixel formed in the image display region of the TFT substrate 133.

The FPCB 110 is a kind of a PCB which connects various electronic components to a printed circuit original board or supports the electronic components according to circuit deign of electric wires. The FPCB 110 is flexible unlike a conventional PCB. The FPCB 110 includes a base film, terminal regions in which metallic sheet patterns are arranged as lead terminals at both ends of the base film, and an interface region in which the metallic sheet patterns are formed as electric wires so that the terminal regions arranged at both ends of the base film are connected to each other and in which a cover lay for protection and insulation of the electric wires is formed. In addition, a plurality of through holes may be formed in the interface region, and the FPCB 110 may further include a region in which the mounted electronic components are connected to the electric wires through the through holes and a predetermined electronic circuit is formed.

One end of the FPCB 110 is connected to an external PCB (not shown), and the other end thereof is connected to an input terminal of the driving IC 131. As such, the gate driving signal, the data driving signal, and the data signal related to the data driving signal are transmitted to the driving IC 131 from the external PCB.

The backlight assembly 150 according to an embodiment of the present invention includes optical sheets 141, a lamp assembly 143, a light guide film 142, a reflection sheet 146, an upper receiving container 140 receiving them, and a lower receiving container 170 combined with the upper receiving container 140.

Here, the light guide film 142 guides light emitted from the lamp assembly 143. That is, the light guide film 142 allows the light generated in the lamp assembly 143 to proceed in a direction of the liquid crystal panel 135 seated on the light guide film 142. Thus, a variety of patterns for changing the proceeding direction of the light incident into the light guide film 142 into the direction of the liquid crystal panel 135 may be printed and formed at a rear side of the light guide film 142. Alternatively, a rigid light guide panel instead of the light guide film 142 may be used.

The lamp assembly 143 is inserted into one side of the light guide film 142 in the upper receiving container 140. The lamp assembly 143 includes a light source and a light source cover. A lamp for use in the lamp assembly 143 may include a light emitting diode (LED), a cold cathode fluorescent lamp (CCFL), a hot cathode fluorescent lamp (HCFL), or an external electrode fluorescent lamp (EEFL).

The reflection sheet 146 is installed at a lower side of the light guide film 142 and reflects light emitted from a lower portion of the light guide film 142 in an upward direction. The reflection sheet 146 reflects the light that is not reflected by fine dot patterns formed at the rear side of the light guide film 142 from the emission side of the light guide film 142 so that loss of light incident into the liquid crystal panel 135 can be reduced and the uniformity of light transmitted to the emission side of the light guide film 142 can be improved.

The optical sheets 141 are seated on the upper side of the light guide film 142 and used to diffuse and condense light transmitted from the light guide film 142. The optical sheets 141 include a diffusion sheet, a prism sheet, a protective sheet, and the like.

The diffusion sheet placed between the light guide film 142 and the prism sheet is used to disperse the light emitted from the light guide film 142 and to prevent light from being partially crowded. The prism sheet is formed in such a way that a triangular prism is formed in a predetermined arrangement at the upper side of the prism sheet. The prism sheet generally includes two sheets and is used to condense light diffused from the diffusion sheet when each prism arrangement is disposed to cross each other at a predetermined angle, in a direction perpendicular to the liquid crystal panel 135. As such, the most part of light that passes through the prism sheet proceeds in a horizontal direction and brightness is uniformly distributed on the protective sheet. The protective sheet formed on the prism sheet is used to protect the surface of the prism sheet and to diffuse light so as to make the diffusion of light uniform. In addition, a black line (not shown) may be formed along an edge of the protective sheet so as to prevent the formation of a bright line or leakage of light that occurs at an edge of a display region of the liquid crystal panel 135.

In the case of the small-sized LCD 100, one lamp is generally installed at a side of the light guide film 142. As the LCD 100 grows larger, a plurality of lamps may be installed in one lamp assembly 143 so as to obtain sufficient brightness.

The liquid crystal panel assembly 130 is installed on the optical sheets 141 and seated on the light guide film 142 together with the optical sheets 141.

A sidewall of the upper receiving container 140 is formed along an edge of a rectangular opening and a predetermined protrusion (not shown) is formed in the sidewall so that the upper receiving container 1409 receives and fixes the liquid crystal panel assembly 130, the optical sheets 141, the lamp assembly 143, the light guide film 142, and the reflection sheet 146 and prevents the plurality of sheets from being bent. The FPCB 110 of the liquid crystal panel assembly 130 is bent centering on one sidewall of the upper receiving container 140. Here, the upper receiving container 140 may be formed in a variety of shapes according to a method of receiving the liquid crystal panel assembly 130, the optical sheets 141, the lamp assembly 143, the light guide film 142, and the reflection sheet 146.

The upper receiving container 140 can be hook-coupled to the lower receiving container 160. For example, a hook 145 may be formed along an outer side of the sidewall of the upper receiving container 140, and a hook insertion hole 172 corresponding to the hook 145 may be formed at a side of the lower receiving container 170. Thus, the lower receiving container 170 is gone up from the lower portion of the upper receiving container 140 so that the hook 145 formed in the upper receiving container 140 is inserted into the hook insertion hole 172 of the lower receiving container 170 and the upper receiving container 140 and the lower receiving container 170 is combined with each other. The present invention is not limited to this, and the hook 145 may be located at the lower receiving container 170 and the hook insertion hole 172 may be formed in the upper receiving container 140. In addition, the upper receiving container 140 and the lower receiving container 170 may be coupled to each other in various manners.

A polarizer included in the LCD according to an embodiment of the present invention will now be described in detail with reference to FIGS. 4 and 5. FIG. 4 is a cross-sectional view of a polarizer included in the LCD according to an embodiment of the present invention, and FIG. 5 illustrates the relationship between a polarizer, a thin film transistor (TFT) substrate, and a color filter substrate.

Referring to FIG. 4, lower polarizer 200 includes a polarization film 210 and a reflective layer 222 formed on a portion of the polarization film 210.

Here, a material having a polarization function may be used for the polarization film 210. There is no special restriction with respect to the polarization film 210. For example, a polyvinylalcohol (PVA)-based film or a partially formulated PVA based film, an elongated film prepared by absorbing iodine and/or dichroic pigment into a hydrophilic polymer film such as an ethylene-acetic acid vinyl copolymer based, partially saponificated film or a cellulose-based film, or a polyene orientated film such as a dehydrating material of polyvinylalcohol or a dehydrochloric acid resultant of polyvinyl chloride may be used for the polarization film 210. The thickness of the polarization film 210 is in a range from about 5-150 μm, preferably, 80-120 μm, but is not limited to this.

An optical diffusion adhesive layer 214 is coated on the polarization film 210. The optical diffusion adhesive layer 214 has a property of diffusing incident light isotropically or anisotropically. In addition, a material having adhesion may be used for the optical diffusion adhesive layer 214. For example, the optical diffusion adhesive layer 214 may be formed in the form of a seat or film shape in which particles having a different refractive index from a matrix having adhesion are diffused. Specifically, the optical diffusion adhesive layer 214 may have a structure in which polystyrene fine particles having an average particle diameter in a range of 0.5-5 μm, organic fine particles such as polymethacryl acid-based fine particles, inorganic-based fine particles such as silica, alumina, titania, zirconia, tartar oxide, indium oxide, cadmium oxide, or antimony oxide, a gas-containing copolymer, and liquid-containing microcapsules are diffused into a matrix formed of an acryl-based adhesive, a rubber-based adhesive, a silicon-based adhesive, an ethylene-acetic acid vinyl copolymer-based adhesive, a urethane-based adhesive, a vinylether-based adhesive, a polyvinyl alcohol-based adhesive, a polyacrylamide-based adhesive, or a mixed adhesive thereof, may be used. More preferably, an acryl-based adhesive having excellent transparency, weatherability, and heat resistance is used for the matrix.

Here, a well-known acryl-based adhesive may be used as an acryl-based adhesive. For example, an adhesive in which acryl-based polymer using first or second species of acryl acid-based alkyl esther formed of esther of acryl acid or methacryl acid having straight chain or diverged alkyl-group of 1˜18 carbon atoms such as a methyl-group, an ethyl-group, an n-prophyl-group, an isoprophyl-group, an n-buthyl-group, an isobuthyl-group, an amyl-group, an isoamyl-group, a hexyl-group, a hepthyl-group, a cyclohexyl-group, a 2-ethylhexyl-group, an octyl-group, an isooctyl-group, a nonyl-group, an isononyl-group, a decyl-group, a undecyl-group, a lauryl-group, a tridecyl-group, a stearoyl-group, or an octhadecyl-group is mainly used may be used.

In addition, for example, an adhesive agent such as petroleum-based rein, rosin-based resin, terpene-based resin, synthetic petroleum-based resin, phenol-based resin, xylene-based resin, alicyclic-based petroleum resin, cumarone inden resin, stylene-based resin, or dicyclopentadiene-based resin, emollient such as puthalic acid ester, phosphoric acid ester, chlorinated paraffin, polybutene, or polyisobutylene, or other various charging agents, antiaging agent, or proper additive such as crosslinking agent may be combined with the optical diffusion adhesive layer 214.

The thickness of the optical diffusion adhesive layer 214 is not particularly limited but may be generally in a range of 1-100 μm, preferably, 5-50 μm, more preferably 10-30 μm.

An adhesive layer 212 is formed on the other side of the polarization film 210. The adhesive layer 212 provides for adhesion between the polarization film 210 and a liquid crystal panel (see 135 of FIG. 3). For example, the adhesive layer 212 may be formed of an acryl-based adhesive, a rubber-based adhesive, a silicon-based adhesive, an ethylene-acetic acid vinyl copolymer-based adhesive, a urethane-based adhesive, a vinylether-based adhesive, a polyvinyl alcohol-based adhesive, a polyacrylamide-based adhesive, or a mixed adhesive thereof.

The thickness of the adhesive layer 212 is not particularly limited but may be generally in a range of 1-100 μm, preferably, 5-50 μm, more preferably 10-30 μm.

As shown in FIG. 4, the polarizer 200 is divided into a reflective region A and a transmissive region B. The transmissive region B is a region in which light emitted from a backlight assembly (150 of FIG. 1) passes through the polarizer 200 and is supplied to a liquid crystal panel (135 of FIG. 1), and the reflective region A is a region in which light incident through the liquid crystal panel (135 of FIG. 1) from the outside is reflected on the polarizer 200 and supplied to the liquid crystal panel (135 of FIG. 1).

A transparent support 220 and a reflective layer 222 formed in the reflective region A of the transparent support 220 are adhered onto one side of the polarization film 210 using the optical diffusion adhesive layer 214.

For example, polyethylene terephthalate (PET), polycarbonate (PC), polyvinylchloride (PVC), polyether Sulfone (PES), polyvinylalcohol (PVA), or triacetyl cellulose (TAC) may be used for the transparent support 220. The thickness of the transparent support 220 is not particularly limited but may be generally in a range of 1-100 μm, preferably, 5-50 μm.

The reflective layer 222 may be formed from a metallic deposition film or metallic thin film. Aluminum, silver, silver-palladium alloy, chromium, or the like may be used for the reflective layer 222. The reflective layer 222 may be formed to a thickness in a range of about 1-10 μm so that the reflection region A of the polarizer 200 has reflectivity of about 75-90% with respect to visible rays. In particular, the reflective layer 222 formed of aluminum has excellent oxidation resistance and thus is not oxidized even though it is formed of a thin film. For example, when aluminum having a thickness in a range of about 1-5 μm is used for the reflective region A, the reflective layer 222 is not oxidized and may have reflectivity of about 80-90%.

An exemplary method of attaching the reflective layer 222 to the polarizer 210 is described as follows. That is, the reflective layer 222 is formed in the reflection region A of the transparent support 220, and the optical diffusion adhesive layer 214 is formed at one side of the polarizer 210. The transparent support 220 is attached to the polarization film 210 so that the reflective layer 222 faces the polarization film 210 when the optical diffusion adhesive layer 214 is placed therebetween. Lower polarizer 200 according to the present invention is not limited to the method and may be fabricated in various ways.

Referring to FIG. 5, in a liquid crystal display (LCD) according to an embodiment of the present invention, one display screen is divided into a main display region 133b in which image information, character information, and the like, which are referred to as main image information hereinafter, are displayed, and a sub-display region 133a in which image information such as time, date, the state of a battery, and the like (hereinafter, referred to as subimage information) are displayed. In general, the subimage information does not require high resolution compared to the main image information. Thus, as shown in FIG. 5, a thin film transistor (TFT) array can be formed on the TFT substrate 133 so that the number of pixels 233b per unit area of the main display region 133b is larger than the number of pixels 233a per unit area of the sub-display region 133a.

The main display region 133b is disposed to correspond to the transmissive region B of the polarizer 200, and the sub-display region 133a is disposed to correspond to the reflective region A of the polarizer 200. The main display region 133b displays the main image information by receiving light from the backlight assembly (150 of FIG. 1). On the other hand, the sub-display region 133a displays the subimage information by reflecting light incident from the outside onto the reflective layer 222 of the polarizer 200. Thus, the backlight assembly (150 of FIG. 1) provides light only to the main display region 133b and does not provide to the sub-display region 133a, or provides light to both the main display region 133b and the sub-display region 133a, that is, provides light having low intensity to the sub-display region 133a so that the entire power consumption of the LCD can be reduced.

In addition, since most subimage information is always needed by a user regardless of the main image information, the LCD according to the present invention can always display the subimage information using external light reflected on the reflective layer 222 of the lower polarizer 200 without driving the backlight assembly (150 of FIG. 1) so that power consumption can be further reduced.

When the LCD according to the present invention is used as a portable display, power consumption is reduced so that a time required for using the LCD can be remarkably reduced.

In addition, as described above, since the reflective layer 222 of the lower polarizer 200 has transmissivity of about 5-25%, high brightness can be produced in the sub-display region 133a by both light from the backlight assembly (150 of FIG. 1) and reflected light.

In the prior art a reflective layer is formed on the TFT substrate 133, which requires a separate mask. Thus, compared to the present invention, manufacturing costs were greater and a process time longer. However, as in the present embodiment, the reflective layer 222 is formed on the lower polarizer 200 and then, the lower polarizer 200 is attached onto the TFT substrate 133 so that power consumption of the LCD can be reduced, manufacturing costs decreased, and display characteristics can be improved.

When the lower polarizer 200 including the reflective layer 222 is attached onto the TFT substrate 133, a process margin should be considered. Thus, as shown in FIG. 5, a black matrix 510 may be formed on the color filter substrate 134 placed at a boundary line between the reflective region A and the transmissive region B of the lower polarizer 200. That is, the black matrix 510 may be formed to overlap with a pixel row 233b of the main display region 133b adjacent to the boundary line between the main display region 133b and the sub-display region 133a and a pixel row 233a of the sub-display region 133a adjacent to the boundary line. For example, the black matrix 510 may have a width in a range of about 400-600 μm. [Delete because that is not Described.]

In addition, even though an edge type backlight assembly having a lamp at a side of the light guide film has been illustrated as an example, the LCD according to an embodiment of the present invention can be applied to a direct-type backlight assembly having a structure in which the light guide film is not provided and a plurality of lamps are arranged at a bottom surface.

As described above, in the polarizer and the LCD having the same according to the present invention, reflected light incident from the outside is used in conjunction with the reflective layer on the polarizer corresponding to the sub-display region so that power consumption of the LCD is reduced and display characteristics are improved.

While the present invention has been particularly shown and described with reference to exemplary embodiments thereof, it will be understood by those skilled in the art that various changes in form and details may be made therein without departing from the spirit and scope of the invention as defined by the following claims and equivalents thereof.

What is claimed is:

1. A polarizer comprising:
a polarization film having a transmissive regipn and a reflective region, wherein the reflective region is comprised of a reflective layer supported on the polarization film.

2. The polarizer of claim 1, wherein the reflective layer comprises a metallic deposition film or metallic thin film.

3. The polarizer of claim 2, wherein the reflective layer is comprised of aluminum, silver, silver-palladium alloy, or chromium.

4. The polarizer of claim 2, wherein the reflective layer has a thickness in a range of from about 1 to about 10 μm.

5. The polarizer of claim 2, wherein the reflective layer comprises a layer of aluminum having a thickness in a range of from about 1 to about 5 μm and the reflective region has reflectivity of about 80-90% with respect to visible rays.

6. The polarizer of claim 1, wherein the reflective region has reflectivity of about 75-95% with respect to visible light rays.

7. The polarizer of claim 1, further comprising an optical diffusion adhesive layer interposed between the polarization film and the reflective layer.

8. The polarizer of claim 7, wherein the optical diffusion adhesive layer has a structure in which particles having a different refractive index from a matrix are diffused onto the matrix formed of an acryl-based adhesive, a rubber-based adhesive, a silicon-based adhesive, an ethylene-acetic acid vinyl copolymer-based adhesive, a urethane-based adhesive, a vinylether-based adhesive, a polyvinyl alcohol-based adhesive, a polyacrylamide-based adhesive, or a mixture thereof.

9. The polarizer of claim 8, wherein the particles are made of at least one kind of particles selected from the group consisting of polystyrene- or polymethacryl acid-based organic fine particles, inorganic-based fine particles including silica, alumina, titania, zirconia, tartar oxide, indium oxide, cadmium oxide and antimony oxide, a gas-containing copolymer, and liquid-containing microcapsules.

10. The polarizer of claim 1, further comprising a transparent support layer, wherein the transparent support layer is positioned on the side of the polarizer which includes the reflective layer.

11. The polarizer of claim 10, wherein the transparent support is made of one selected from the group consisting of polyethylene terephthalate (PET), polycarbonate (PC), polyvinylchloride (PVC), polyether sulfone (PES), polyvinylalcohol (PVA), and triacetyl cellulose (TAC).

12. A liquid crystal display comprising:
a liquid crystal panel having a main display region and a sub-display region, the liquid crystal panel having first and second sides;
a backlight assembly positioned adjacent the first side of the liquid crystal panel, the backlight assembly being adapted to provide incident light onto the first side of liquid crystal panel;
a lower polarizer positioned intermediate the backlight assembly and the first side of the liquid crystal panel, the lower polarizer comprising a polarizing film for polarizing the incident light;
a reflective layer formed on the lower polarizer, wherein the reflective layer is positioned corresponding to the sub-display region; and
an upper polarizer positioned adjacent the second side of the liquid crystal panel, the upper polarizer being adapted to polarize incident light passing through the liquid crystal panel.

13. The liquid crystal display of claim 12, wherein the liquid crystal panel comprises:
a thin film transistor (TFT) substrate on which a plurality of switching elements are formed;
a color filter substrate which faces the TFT substrate and on which a color filter is formed; and
a liquid crystal layer interposed between the TFT substrate and the color filter substrate, and
wherein a black matrix is formed on the color filter substrate corresponding to a boundary line of the main display region and the sub-display region.

14. The liquid crystal display of claim 13, wherein the black matrix overlaps with a pixel row of the main display region adjacent to the boundary line and a pixel row of the sub-display region adjacent to the boundary line.

15. The liquid crystal display of claim 13, wherein the black matrix has a width in a range of about 400 to about 600 μm.

16. The liquid crystal display of claim 12, wherein main image information about image information or character information is displayed in the main display region and subimage information about time, date, or a state of a battery is displayed in the sub-display region.

17. The liquid crystal display of claim 12, wherein the reflective layer comprises a metallic deposition film or metallic thin film.

18. The liquid crystal display of claim 17, wherein the reflective layer is comprised of aluminum, silver, silver-palladium alloy, or chromium.

19. The liquid crystal display of claim 17, wherein the reflective layer has a thickness in a range of from about 1 to about 10 μm.

20. The liquid crystal display of claim 17, wherein the reflective layer comprises a layer of aluminum having a thickness in a range of from about 1 to about 5 μm and the reflective region has reflectivity of about 80-90% with respect to visible rays.

21. The liquid crystal display of claim 12, wherein the reflective layer has reflectivity of from about 75-95% with respect to visible light rays.

22. The liquid crystal display of claim 12, further comprising an optical diffusion adhesive layer interposed between the polarization film and the reflective layer.

23. The liquid crystal display of claim 22, wherein the optical diffusion adhesive layer has a structure in which particles having a different refractive index from a matrix are diffused onto the matrix formed of an acryl-based adhesive, a rubber-based adhesive, a silicon-based adhesive, an ethylene-acetic acid vinyl copolymer-based adhesive, a urethane-based adhesive, a vinylether-based adhesive, a polyvinyl alcohol-based adhesive, a polyacrylamide-based adhesive, or a mixture thereof.

24. The liquid crystal display of claim 24, wherein the particles are made of at least one kind of particles selected from the group consisting of polystyrene- or polymethacryl acid-based organic fine particles, inorganic-based fine particles including silica, alumina, titania, zirconia, tartar oxide, indium oxide, cadmium oxide and antimony oxide, a gas-containing copolymer, and liquid-containing microcapsules.

25. The liquid crystal display of claim 12, further comprising a transparent support layer formed on the side of the lower polarizer which includes the reflective layer.

26. The liquid crystal display of claim 25, wherein the transparent support is made of one selected from the group consisting of polyethylene terephthalate (PET), polycarbonate (PC), polyvinylchloride (PVC), polyether sulfone (PES), polyvinylalcohol (PVA), and triacetyl cellulose (TAC).
